(19) United States
(12) Patent Application Publication
(10) Pub. No.: US 2022/0084101 A1
(43) Pub. Date: Mar. 17, 2022

(54) Interactive virtual menu for restaurants

(71) Applicant: Danial Rahbar, Palo Alto, CA (US)

(72) Inventor: Danial Rahbar, Palo Alto, CA (US)

(21) Appl. No.: 17/023,517

(22) Filed: Sep. 17, 2020

(51) Int. Cl. G06Q 30/06; G06Q 20/08; G06Q 20/32; G06Q 10/02; H04L 29/06; G06K 7/14

(52) U.S. Cl. CPC G06Q 30/0633; G06Q 30/0625; G06Q 20/085; G06Q 30/0282; G06Q 10/02; H04L 63/083; G06K 7/1417; G06Q 20/3267

(57) ABSTRACT

A software application driven virtual menu and system for restaurants is provided. The system allows for the participation of multiple restaurants in a given geographic area. The virtual menu is customizable to allow each restaurant to populate the food selections and various options in a manner appropriate for the type of cuisine being ordered. A user can search for a particular restaurant or type of food to start the ordering process. Once the restaurant has been selected the user can then select between dine in, delivery, or takeout. The user can then pay for a completed order and the order delivered via dine in, delivery, or takeout with no need to physically interact with restaurant personnel. The system is user friendly for both customer and employee and allows for contactless food delivery for dine-in customers from a single application.

### 1. FIELD OF THE INVENTION

The present invention generally relates to interactive software driven menus. More specifically, the present invention relates to a method and system of contactless food ordering in a restaurant setting.

### BACKGROUND OF THE INVENTION

Software driven virtual menu systems for restaurants have been available for many years. With the advance of computer electronics, devices such as smart phones and tablets have become portals for ordering virtually every product. In light of the global pandemic, the utility of the software applications driving virtual menu systems has become paramount. These systems, while generally effective, suffer from drawbacks. Chief among these is that there is no uniformity or standardization for these applications so that consumers have a learning curve which is often problematic for older patrons and those not computer literate. Also, the applications tend to be take out specific, that is, they can only be used for placing take out or delivery orders. For bars and restaurants allowing in house dining, these applications are not useful and the waitstaff must physically approach the table risking infection.

### SUMMARY OF THE INVENTION

A software application driven virtual menu and system for restaurants is provided. The system allows for the participation of multiple restaurants in a given geographic area. The virtual menu is customizable to allow each restaurant to populate the food selections and various options in a manner appropriate for the type of cuisine being ordered. A user can search for a particular restaurant or type of food to start the ordering process. Once the restaurant has been selected the user can then select between dine in, delivery, or takeout. The system allows for virtual payment for delivery, carry out, and dine-in using the same application. The system is user friendly for both customer and employee and allows for contactless food delivery for dine-in customers from a single application.

It is a major object of the invention to provide an improved virtual menu system for restaurants.

It is another object of the invention to provide an improved virtual menu system for restaurants that can be used to find participating restaurants in a given area.

It is another object of the invention to provide an improved virtual menu system for restaurants that is customizable.

It is another object of the invention to provide an improved virtual menu system for restaurants that allows for virtual payment for carry out delivery, and dine in.

### BRIEF DESCRIPTION OF THE DRAWINGS

FIG. 1 shows a screen capture of a login page as displayed on a computing device used with the inventive application.

FIG. 2 shows a screen capture of a search page for restaurants.

FIG. 3 shows a screen capture of a search page for bars.

FIG. 4 shows a screen capture of a search page.

FIG. 5 shows a screen capture of a reservation page.

FIG. 6 shows a screen capture of a reservation page.

FIG. 7 shows a screen capture of a reservation page.

FIG. 8 shows a screen capture of a QR code scan page.

FIG. 9 shows a screen capture of a QR code scan page.

FIG. 10 shows a screen capture of a search page displaying a selected restaurant.

FIG. 11 shows a screen capture of an order page.

FIG. 12 shows a screen capture of a menu on an order page.

FIG. 13 shows a screen capture of an order page.

FIG. 14 shows a rating page.

FIG. 15 shows an account information screen capture.

FIG. 16 shows a screen capture of the takeout/dine in option.

FIG. 17 shows a screen capture of the takeout order page.

FIG. 18 shows a screen capture of the dine in order page.

FIG. 19 shows a log in page for management/employees.

FIG. 20 shows a screen capture of the management only log in page.

FIG. 21 shows a screen capture of the management only home page.

FIG. 22 shows a screen capture of the employee page designating active tables.

FIG. 23 shows a screen capture of the kitchen staff page.

FIG. 24 shows a screen capture of the order placed.

FIG. 25 shows a screen capture of the management/employee table view page.

FIG. 26 illustrates an overview of the environment within which the inventive method is practiced.

### DETAILED DESCRIPTION

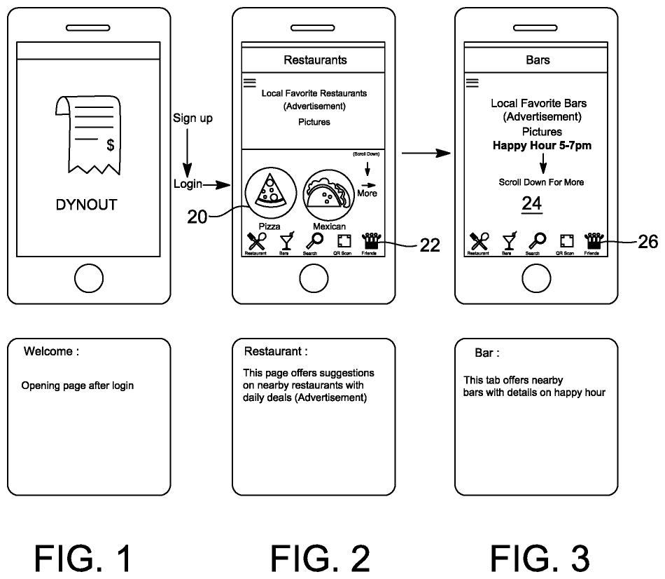

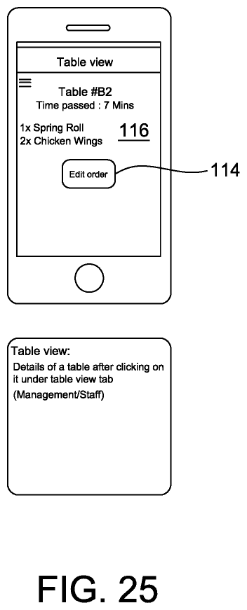

The present invention is directed to a customizable software application and system for contactless ordering of food from a restaurant menu as illustrated in FIGS. 1-26. It can be appreciated that the software application is designed to be implemented on a computing device such as a smart phone, tablet etc., generally indicated by the numeral 10. The device 10 is connected in the well known manner to a wide area network, e.g., the internet 35, in order to send and receive data from a variety of sources. Thus, the inventive system can be used by any user having an internet capable device 10. The system contemplates one or more restaurants/bars in a local area participating, so that a user will not have to learn to interface with a new application for each restaurant. Also, the user can save financial and other data/credentials so that these only need be entered once. The restaurants/bars will have one or more computing devices allowing access to a computing device in the form of a server or the like, by which their information including a customized interactive menu, is available to the user over the wide area network. The central remote server, also accessible via the wide area network, stores the application software, and communicates updates etc. to both the user device and the restaurant computing device. Thus, the user device can communicate orders etc. to the restaurant computing device, with a central server controlling all aspects of a food order transaction as described below.

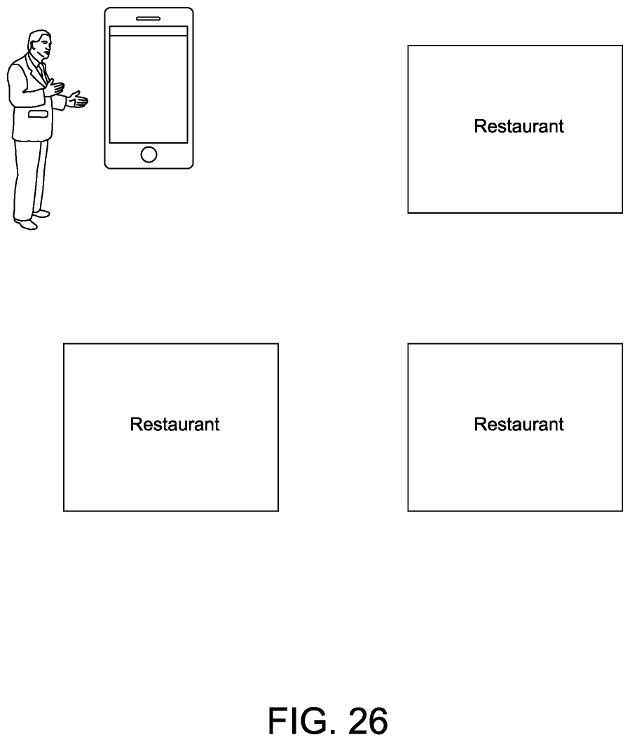

With particular reference to FIG. 26, an environment in which the inventive method may be used is shown. In this scenario a user with a smartphone 10 is in proximity to several local restaurants 29.

Each business 29 has at least one computing device or resource 33 associated therewith, and each computing resource 33 is preloaded with the application software of the invention, this version of the application specific to the restaurant staff 29 as explained below, so that commands and instructions between smartphone 10 and restaurant computing device 33 are conducted using the same protocols. The restaurant 29 computing resource 33 can be as simple as another smartphone, or could be a laptop or tablet. Several persons at the restaurant will have the application specific to the restaurant, the users including management, servers, chefs, etc. Communication between the smartphone 10 and computing resource 33 is facilitated by central server 37 via the internet 35 or other communication network such as a WAN. The central server 37 is used to store and transmit both the customer and restaurant 29 version of the application, and allows for the presentation of displays on both the computing resource 33 and the user device 10 to effect completion of a food order including payment.

In order to start using the inventive system, the users (both customer and restaurant management/employees) must first download the appropriate version of the inventive application from the central server 37. The user/customer application is detailed in FIGS. 1-18. The user/customer device 10 will display the screen shown in FIG. 1 when the application is initiated by the user, this screen being the log in page which allows the user to enter a name and password. Once the user has been verified by entering the appropriate data, all financial credentials, addresses, and past orders associated with the user are immediately available.

After log in, the user is presented a restaurant search page 16 (FIG. 2) which lists all “favorite” restaurants which may be restaurants that the user has frequented or used at least once, as well as local favorites. The list may be supplemented by additional nearby restaurants, the supplemental list generated based on the current geographical position of the user as is known in the art. Broad food categories may be presented by GUI icons 20 which may be illustrations only. The user may then click on the GUI which allows interfacing with the application in the well known manner. On the bottom of the page is a taskbar 22 which lists all search options. The options include search restaurants, bars, friends, QR code, or search all.

FIG. 3 shows a bar search page 24 with a taskbar 26 identical to that of FIG. 2. Clicking on the bars GUI 25 will search for bars currently having happy hour. By clicking on a bar on the list, the user can get details about the happy hour specials for that business 29. As in the above scenario, the list is based on the geographical position of the user.

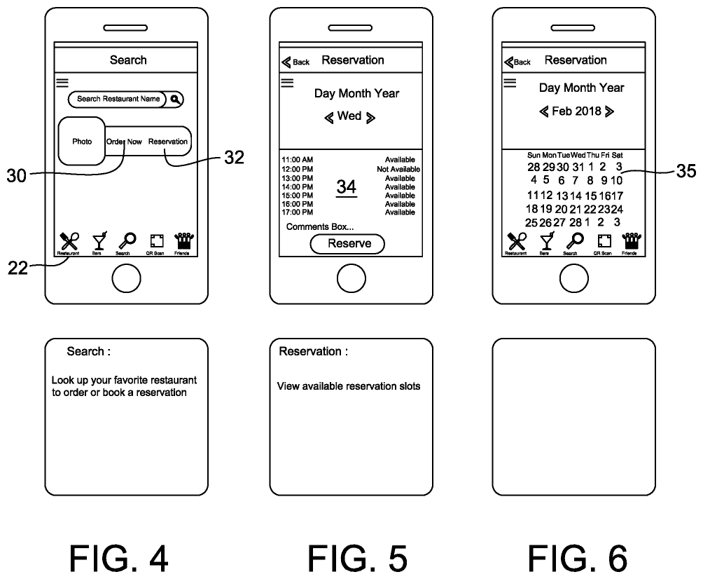

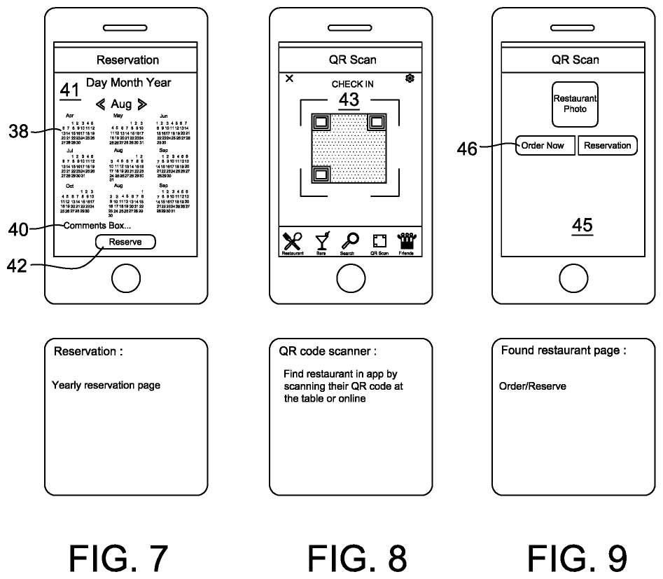

FIG. 4 shows a result that the user has “clicked” on, i.e., a found entry from the search results list selected using the cursor in the well known manner. Task bar 22 remains but the selected entry offers 3 options: presentation of a photo of the restaurant, an order now GUI 30, and a reserve GUI 32. If the user clicks reserve 32, the screen of FIG. 5 is presented, listing time and date options 34. FIG. 6 shows details 35 of the time and date, as does FIG. 7, see 38. A text box 40 on screen 41 allows the user to enter notes about the reservation before clicking reserve 42 to finalize the reservation.

FIG. 8 shows a search page 43 that allows for the scanning of the restaurant QR code, which scanning allows for the instant presentation of the screen 45 of FIG. 9 which again allows the user the option of ordering or reserving. If the user clicks on ORDER

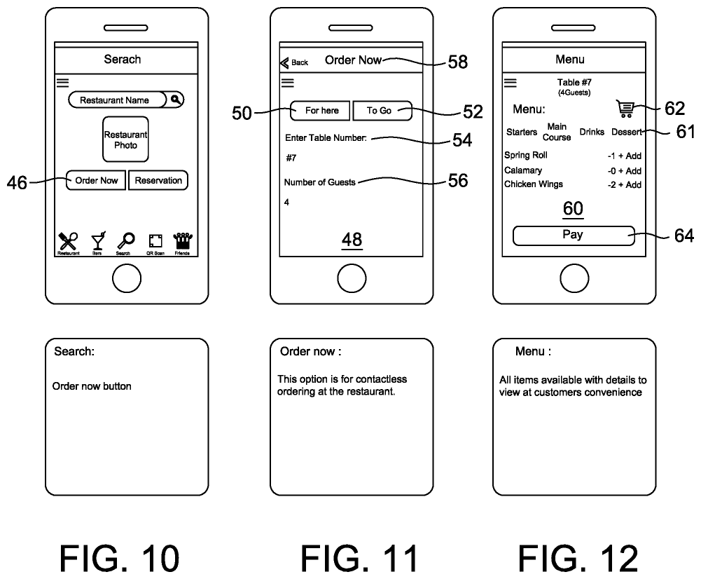

NOW 46 as shown in FIG. 10, screen 48 of FIG. 11 is shown. The screen 48 allows the user to click on one of the following options:

### FOR HERE 50

### TO GO 52

### ENTER TABLE NUMBER 54

### ENTER NUMBER OF GUESTS 56.

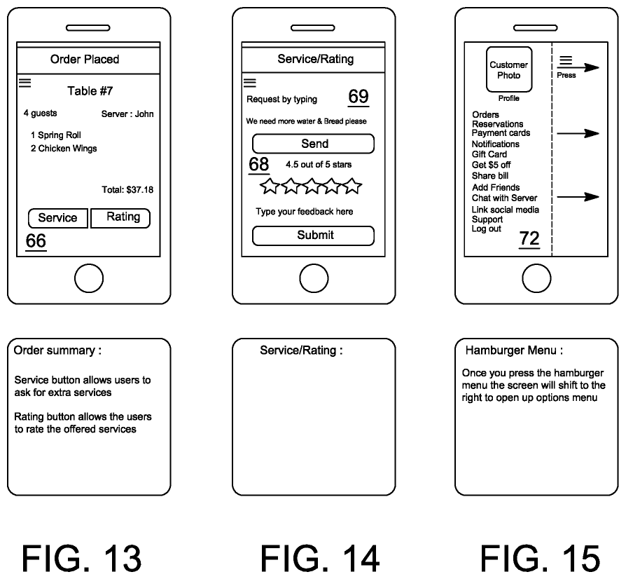

The user selects one of options 50-56 so that the restaurant/bar knows where to deliver the order. The user then clicks ORDER NOW 58 to advance to screen 60 in FIG. 12 where a menu bar 61 is presented, as well as confirmation of the destination of the order as selected on screen 48. The user populates the cart 62 with items selected from the menu and then clicks PAY 64 to advance to screen 66 in FIG. 13. Screen 66 allows the user to enter a rating of the service provided by clicking on GUI 65, which rating can be entered and submitted on screen 68 of FIG. 14. The user can also request specific services such as extra ice water by, which services request can be typed into box 69 on screen 68.

An options GUI 70 on screen 66 allows the user to access an account page 72 (FIG. 15) where the user can enter and edit personal/financial information. The account page 72 also allows the user to check all reservations and orders, gives system updates, allows for bill sharing, provides a chat option with the waitstaff, and provides access to system support. The account page 72 also allows the user to link to social media, add friends, access discounts, and share the bill with a designated person, an especially convenient option when dining out. The designated person would have to be a logged in registered user connected to server via a user device 10. The designated person can access their account to find a cart 86 pouplated with the portion of the order to be paid by the designated person. The designated person would then pay in the manner described below.

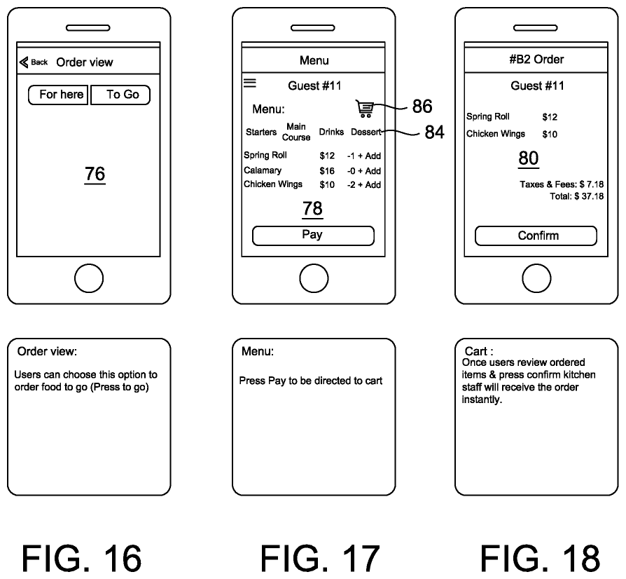

FIG. 16-18 show screens 76, 78, and 80 which are presented if the user selects TO GO 52 from screen 48 in FIG. 11. A menu 84 and cart 86 are presented on screen 78, and when the user has finished the order, the PAY/SEND 88 icon is clicked on to present the cart 86 on screen 80 whereupon the user can click confirm 89, at which point the order is sent to management/employees.

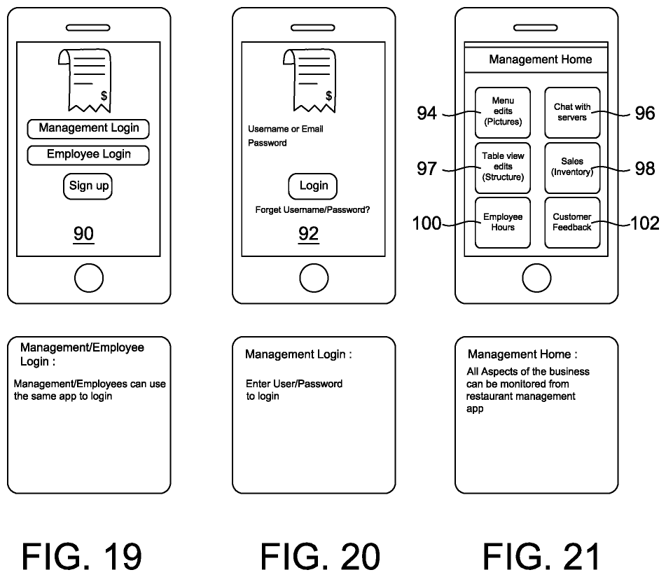

FIGS. 19-25 show the management/employee screens. FIGS. 19/20 show the startup/log in screens 90, 92 where user name and passwords may be entered to allow management/employees access the inventive application.

FIG. 21 is the main employee page which has the following GUIs/selection options:

### MENU 94

CHAT 96 (to allow chat between user and server)
TABLE VIEW 97 (illustrating the relative position of the tables in the restaurant.)
SALES 98 (showing a summary of all sales for a given selected period.

### EMPLOYEE HOURS 100, AND

### FEEDBACK 102.

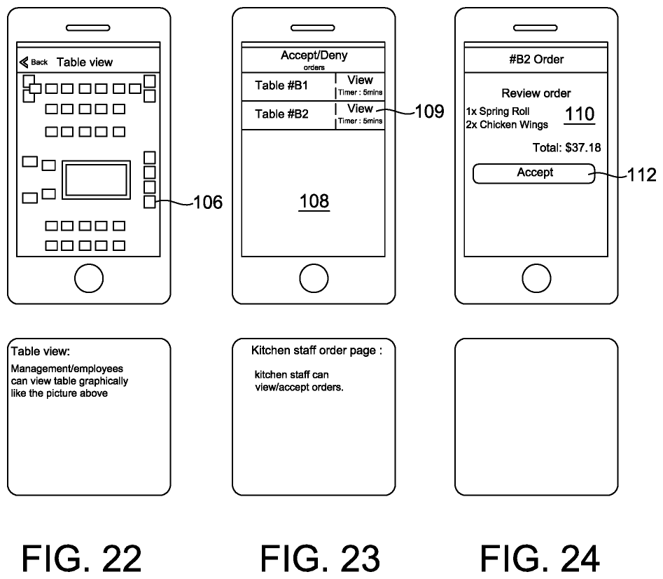

FIG. 22 shows the table view screen 104 where GUIs 106 representing tables are shown. The employee may click on any of the GUIs 106 to see what order corresponds to that selected table. FIG. 23 shows a detailed table page 108 where the orders for a selected table can be viewed, as well as the elapsed time since the order was submitted. Clicking on the view icon presents the employee with the order for the selected table as shown on screen 110.

The employee may click ACCEPT 112 to enter the order for processing/preparation. Finally, an edit order GUI 114 is presented on screen 116 to allow an employee to edit an order based on a user request as discussed above.

I claim:

1. A computer implemented method for ordering food from a restaurant/bar, the method allowing electronic communication between at least one user device associated with a user and a restaurant/bar device associated with a restaurant/bar, said user device and said restaurant/bar device connected to a network comprising the steps of:
selecting a restaurant or bar with said user device from a list of restaurant or bars presented in response to a search request initiated by said user;
selecting a type of service desired from the restaurant or bar;
ordering a desired item or items from a menu presented;
paying for the desired item or items; and,
having the desired item or items delivered in accordance with the type of service requested.

2. The method of claim 1 wherein said type of service can be delivery, take out, or dine in.

3. The method of claim 1 where the user selects a bar from said list, and a list of happy hour specials are presented.

4. The method of claim 1 wherein a graphical representation of table arrangement within said restaurant or bar can be displayed on said restaurant/bar device.

5. The method of claim 1 wherein a server is connected to said network, and including the step of transmitting a first application to said user device and a second application to said restaurant/bar device.
